(19) United States
(12) Patent Application Publication
(10) Pub. No.: US 2004/0094973 A1
(43) Pub. Date: May 20, 2004

(54) Dicplaceable door handle system

(76) Inventor: Gary Sprague, Redondo Beach, CA (US)

Correspondence Address: Mitchell P. Brook, Esq., Luce Forward Hamilton & Scripps LLP, Suite 200, 11988 El Camino Real, San Diego, CA, 92130, US

(21) Appl. No.: 10/331,036

(22) Filed: Dec. 27, 2002

Related U.S. Application Data
(63) Continuation-in-part of application No. 10/299,422, filed on Nov. 18, 2002.

(51) Int. Cl. E05B 3/00

(52) U.S. Cl. 292/336.3

(57) ABSTRACT

A displaceable door handle system is provided in which a door handle is displaceably mounted to a door body and is shaped so that the pivot point(s) are sufficient operational distances from an actuation surface such that the force necessary to be applied to the actuation surface to release the door is less than a desired parameter. In a preferred embodiment, a generally horizontal surface is provided on the door handle, with two generally vertical surfaces provided on either side of the actuation surface. The pivot mounts for the door handle are provided in the vicinity of the respective ends of the vertical surfaces.

This application is a continuation-in-part of commonly owned co-pending U.S. patent application Ser. No. 10/299,422, entitled “Door Handle Actuated Electronic Egress System”.

### FIELD OF THE INVENTION

The present invention generally relates to displaceable door handles and locks. More particularly, the invention concerns a pivoting door handle system, such as can be used for panic handles and other types of door handles.

### BACKGROUND OF THE INVENTION

Various forms of pivoted door handle and panic handle mechanisms exist in which a door handle is pivotally mounted on a door, with a latch operatively connected to the handle such that when the handle is pivoted, the door unlatches. An example of such a pivoting door handle is shown in U.S. Pat. Nos. 4,711,480. In such known pivoting handle systems, when the handle is depressed, a latching mechanism is actuated to unlatch the door. In order to do so, however, typically friction forces as well as spring forces incorporated in the handle assembly, if any, must be overcome. For example, there can exist friction at the hinges between the door and the door frame, between the edge of the door and the door frame, at the pivot assemblies, and in the handle. In addition to friction, there can be inertia forces must be overcome in order to swing the heavy door into motion from a stationary position. A person opening the door must apply enough force to the handle to overcome the opposing spring, friction and inertia forces.

Certain people such as children and the elderly may experience difficulty applying sufficient force to the handle to overcome the spring, friction and inertia forces and open the door. In the case of fire or other emergency, a person may be trapped in a building, unable to overcome the friction and inertia forces and open the door. Standard setting bodies have established criteria for standards grading that address such situations. In one known standard, a maximum force of 15 lbf. (67N) is proscribed. This can be found, for example in Section 7.2 of the American National Standard For Exit Devices, Approved Jul. 2, 2001 by the American National Standards Institute, Inc. and developed by the Builders Hardware Manufacturers Association, Inc. (ANSI/BHMA A156.3-2001). This standard also specifies that an actuating surface should be visually and physically distinct. In further complication, the amount of force applied to unlatch a pivoting handle can vary depending upon the location on the handle at which the force is applied is pushed. For example, in a known L-shaped handle design as shown in Ser. No. 4,711,480, if the force is applied in the proximity of the pivot point at an end of the “L”, it can be relatively more difficult or impossible to generate adequate force to oppose the requisite spring and/or friction forces and pivot the handle to unlatch the door. In view of these drawbacks, there exists a need for a panic door handle that provides a larger operative region for generating requisite loads to unlatch and open a door.

### SUMMARY OF THE INVENTION

The present invention alleviates to a great extent the disadvantages of the known door handles by providing a door handle that is pivotally mounted to a door body that is shaped so that the pivot point(s) are sufficient operational distances from an actuation surface such that the force necessary to be applied to the actuation surface to release the door is less than a desired parameter. More particularly, the present invention provides an enhanced actuation surface for a door handle system, such as for example a panic handle system. According to some embodiments of the present invention a handle with an actuation surface and a lever arm between a mounting or pivot assembly and the actuation surface. For example, the door handle in an embodiment generally has a J-shape with mounting assemblies located at or near distal ends of the “J”. Should a person apply force at the actuation surface along the bottom of the “J”, then the force will be applied at a sufficient distance from both pivot assemblies so that the door can be opened within a desired range of actuation force. The extended lever arm presented in this construction over an “L” construction can result in a relatively lower required force applied on the actuation surface, for any given handle compression resistance? in order to unlatch the door.

In one embodiment of the present invention, the actuation surface is further enhanced with a directional force application marker is provided on an actuation surface of the door handle. In this embodiment, the door handle may be any shape, including “L”, “J” and other shapes.

Some advantages of the present invention include: decreased force required to open door; applied force more efficiently utilized because the applied force can be better aligned with the pivot direction; door more likely to meet building regulations and codes within the U.S. and elsewhere; door more convenient to open because less force is required and force is efficiently employed; smoother actuation of door handle and door; and door less likely to trap people in case of emergency.

These and other features and advantages of the present invention will be appreciated from review of the following detailed description of the invention, along with the accompanying figures in which like reference numbers refer to like parts throughout.

### BRIEF DESCRIPTION OF THE DRAWINGS

FIG. 1 is a flowchart depicting operation of an embodiment of a door handle system in accordance with the present invention;

FIG. 2 is a front view of an embodiment of a door handle system in accordance with the present invention;

FIG. 3 is a side view of an embodiment of a door handle system in accordance with the present invention;

FIG. 3A is a detail of a side view of an actuation system of a door handle system in accordance with the present invention;

FIG. 4 is a front view of an embodiment of a door handle system in accordance with the present invention;

FIG. 5 is a front view of an embodiment of a door handle system in accordance with the present invention;

FIG. 6 is a front view of an embodiment of a door handle system in accordance with the present invention;

FIG. 7 is a front view of an embodiment of a door handle system in accordance with the present invention;

FIG. 8 is a front view of an embodiment of a door handle system in accordance with the present invention;

FIG. 9 is a front view of an embodiment of a door handle system in accordance with the present invention;

FIG. 10 is a perspective view of an embodiment of a door handle system in accordance with the present invention;

FIG. 11 is a cross-sectional view of an embodiment of a door handle system in accordance with the present invention;

FIG. 12 is a cross-sectional view of an embodiment of a door handle system in accordance with the present invention;

FIG. 13 is a perspective view of an embodiment of a door handle system in accordance with the present invention;

FIG. 14 is a cross-sectional view of an embodiment of a door handle system in accordance with the present invention;

FIG. 15 is a cross-sectional view of an embodiment of a door handle system in accordance with the present invention; and

FIG. 16 is a front view of an embodiment of a door handle system in accordance with the present invention.

### DETAILED DESCRIPTION OF THE INVENTION

In the following paragraphs, the present invention will be described in detail by way of example with reference to the accompanying drawings. Throughout this description, the preferred embodiments and examples shown should be considered as exemplars, rather than as limitations on the present invention. As used herein, the “present invention” refers to any one of the embodiments of the invention described herein, and any equivalents. Furthermore, reference to various aspects of the invention throughout this document does not mean that all claimed embodiments or methods must include the referenced aspects.

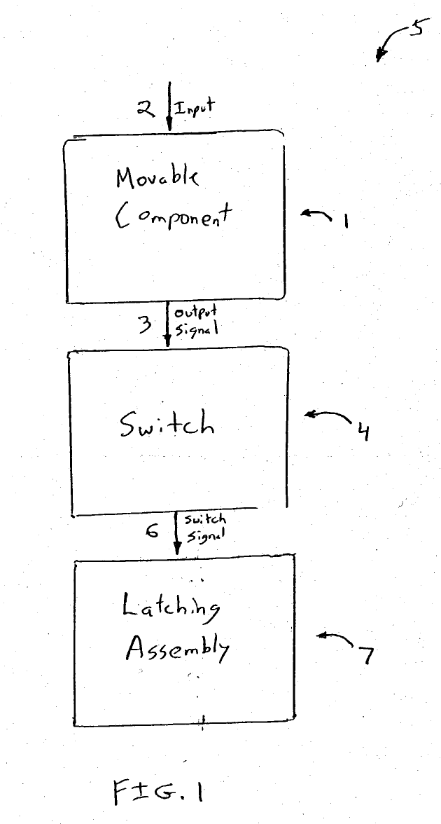

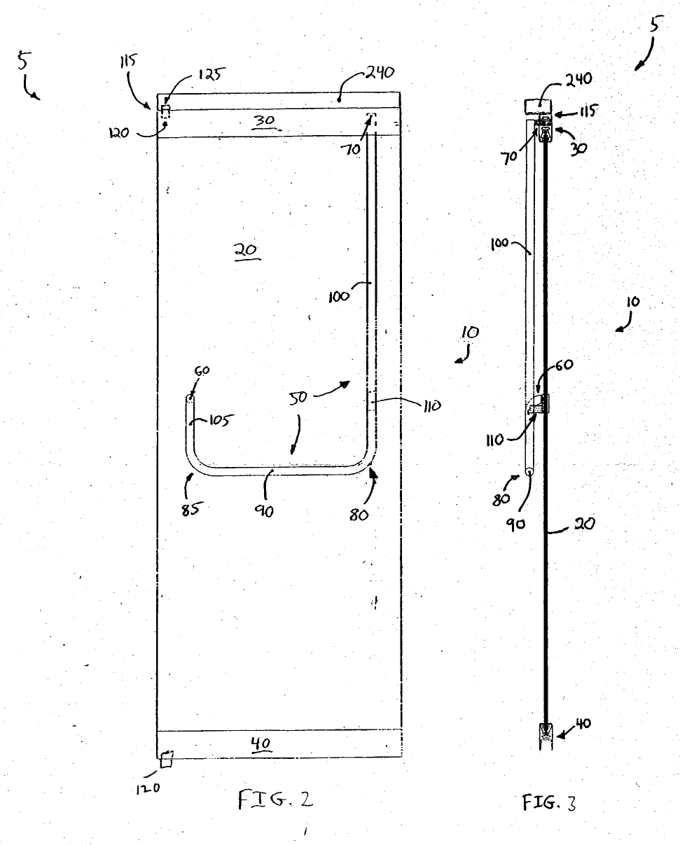

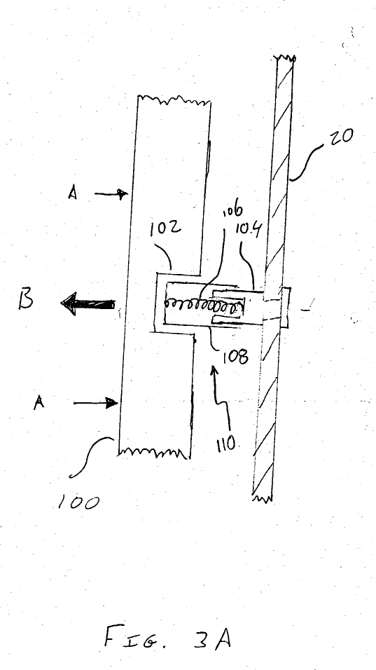

FIGS. 1-4 illustrate an embodiment of a displaceable door handle system 5 according to the present invention. Generally speaking, the system 5 includes a movable component that can receive actuation via a pressure input 2 in the direction indicated by arrows A in FIG. 3. Typically, the pressure input would be by a person seeking to open a door pushing on the movable component 1, such as by hand, back, foot or other body part. Alternatively a mechanical pressure input 2 in direction A could be provided such as via a wheelchair or other assistant device such as prosthesis or cane. The movable component 1 can be any component that can withstand the pressure input and move at least a predetermined distance as desired from the pressure input 2. In one example, the movable component is a door handle 50 appropriately mounted so as to displace relative to the door body 20 in response to the pressure input 2. Upon being actuated by the pressure input 1, the movable component 1 results in an output signal 3, such as a mechanical motion of a linkage or other mechanical translation actuator. Alternatively, an electronic signal can be generated using an electronic actuator. The electronic actuation embodiment is illustrated in FIG. 1, and in that embodiment, the output signal is received by an optional switch, 4, which in turn outputs optional switch signal 6. It should be understood however that a preferred embodiment for a panic handle system does not include switch 4 and switch signal 6, and instead a mechanical linkage assembly is actuated such as by output signal 3 to directly unlatch latching assembly 7. In an embodiment including switch 4, switch signal 6 alternatively can be an analog electrical signal, digital signal, or alternatively a wireless signal. The switch signal is transmitted to a locking or latching assembly 7, which is actuated by the signal to unlock or unlatch the door. For example, the locking or latching assembly 7 can receive an analog signal that operates an electronic unlocking or unlatching mechanism in the locking or latching assembly 7. Alternatively, locking or latching apparatus may receive a digital signal 6, and include an A/D converter that converts the digital signal into an analog signal and thereby operates an electronic unlocking or unlatching mechanism. In a wireless embodiment, the locking or latching mechanism 7 includes a wireless receiver that receives signal 6, and operates to unlock or unlatch the door.

Turning to a specific embodiment, as depicted in FIGS. 2, 3 and 3A, the displaceable door handle system 5 comprises a door 10 including a door body or door panel 20 having a one of a top door rail 30 or a bottom door rail 40 affixed thereto. In an alternative embodiment, the system includes both a top door rail 30 and bottom door rail 40, as illustrated in FIG. 2. A door handle 50, such as for example a generally J-shaped handle 50 is mounted onto the panel 20. Preferably, the handle 50, in at least some portion of it defines an interior space, i.e. is hollow. The linkage assembly is located in such a space. However, it should be understood that the handle 50 need not include such a space and a linkage can be located elsewhere on handle 50 for unlatching the door.

The handle 50 can be attached to the door in any fashion. In one embodiment, the handle 50 is pivotally mounted to the door at mounting assemblies 60, 70 (“pivot assemblies” and “mounting assemblies” may include any type of connector and also are referred to herein as “pivot points”) near or at its respective ends. Alternatively, it may have a single pivot point or any other number of pivot points such that the handle can be mounted to the door body 20. Any type of pivot assembly or other type of connector assembly may be used that is sufficient to mount the handle 1 to the door body 20 while still enabling relative motion between the handle 50 and door body 20 at a desired location on the handle 50.

Any shaped handle 50 may be used. For a panic handle embodiment, as illustrated in FIGS. 2-10, a bent handle 50 may be used, in various shapes, such as, J-shaped, angled etc. In an illustrated embodiment, the handle 50 has a pair of bends 80,85 forming a generally J-shaped handle 50 including an actuation surface 90, that is horizontal in a J-shaped embodiment (also called “horizontal bar”), a vertical portion 100 (also called “vertical bar”) and a handle extension portion 105. In the embodiment shown in FIG. 2 a generally 90 degree angle is provided at bends 80 and 85. any other angle may be used as well, including, but not limited to 30, 60, 85, 95, 120, 150, 270 and 305 degree angles.

The actuation surface 90 is adapted to be pushed (such as in direction A illustrated in FIG. 3) to open the door 10. A lever arm can be created in the present system by locating pivot point 60 spaced away from actuation surface 90. Although the actuation surface 90 is illustrated as horizontal, it should be understood that it can have other orientations as well, such as vertical. Likewise, a user is free to push on handle 50 at any point on it, although generally speaking the force required in direction A for unlatching typically will be higher at areas not within the actuation surface.

As seen in FIG. 2, some embodiments involve a generally J-shape handle 50 with the pivot points 60,70 located at or close to each distal end 60,70. Thus, the present invention incorporates a moving pivot 60 spaced away away from the actuation surface 90 and connected via lever arm surface 105. The distance created between pivot point 60 and the actuation surface 90 can result in an increased lever arm. Adjusting the lever arm distance (and length of lever arm surface 105) can change the amount of force required on actuation surface 90 to unlatch the door.

As illustrated in FIG. 3A, in a preferred embodiment, the handle 50 includes an indentation or aperture 102 that is adapted to receive an actuator post assembly 110 that extends from the door panel 20 and toward, or alternatively into, indentation or aperture 102. The actuator post assembly can include a solid element extending from the door panel 20 that has sufficient structural strength to remain in tact when handle is depressed and contacts the assembly 110. In the embodiment illustrated in FIG. 3A, the actuator post assembly includes a spring resistance that resists relative motion of the door handle 50 towards the door panel 20. Preferably, a sufficient amount of spring resistance is provided to make the door handle relatively stable when not being actuated, and to provide a desired amount of resistive force in direction B opposing actuation force in direction A. In the illustrated embodiment, the spring resistance is provided by spring element 106 mounted within post mount 104 and cap 108. It should be understood that any type of spring element may be used, including without limitation a coil spring, hydraulic spring, or any other form of spring loading element. Although the illustrated embodiment depicts the spring resistance (in direction B) is provided at an area on the door handle, it should be appreciated that the resistance element(s) 106 can be provided at any location or plural locations on the door handle such that the desired resistance can be provided. For example, if it is desired to have a 15 lbf. resistance at the actuation surface of the door handle, plural resistance elements may be located, for example all in the vertical portion(s) or all in the horizontal portion(s) or alternatively in a combination of vertical, horizontal or angled portions of the door handle 50. Likewise single resistance elements can be provided at any desired location so long as the desired resistance is provided at the actuation surface. It should be recognized that the increased lever arm provided in the present invention permits a relatively greater spring resistance to be provided if desired as the lever arm assists with a user to achieve a greater force in direction A at the resistance point.

In the embodiment shown in FIGS. 2 and 3, a generally 90-degree angle is provided at bend 80 such that the vertical bar 100 extends upward from the bend 80 and into top door rail 30. In addition, a generally 90-degree angle is provided at bend 85 and extension 105 extends upward from actuation surface 90, but does not extend into the top door rail 30. Alternatively, extension 105 may extend to any point, including up to top door rail 30.

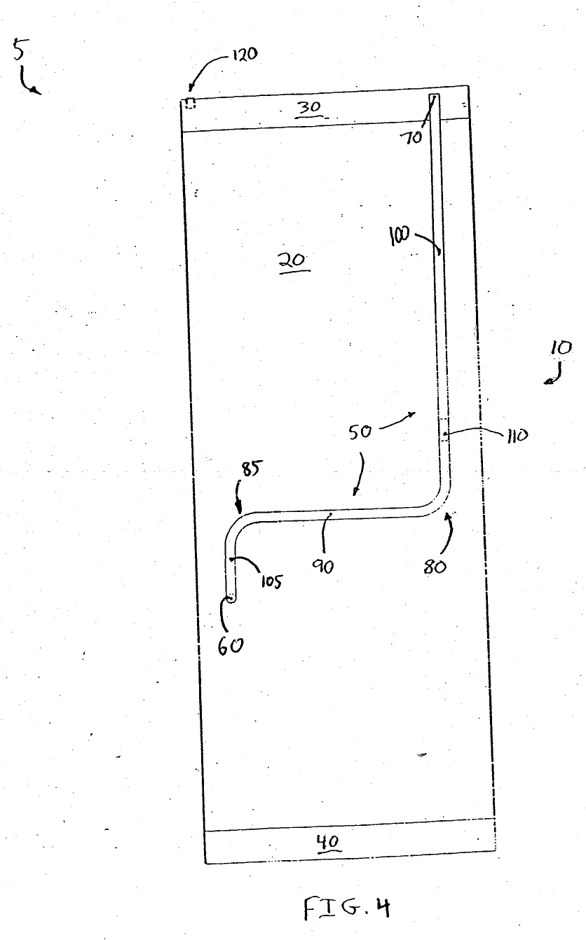

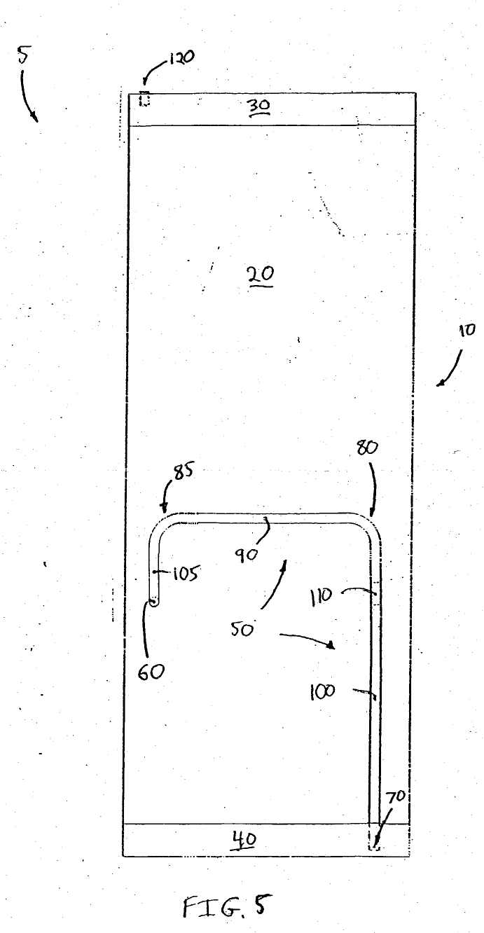

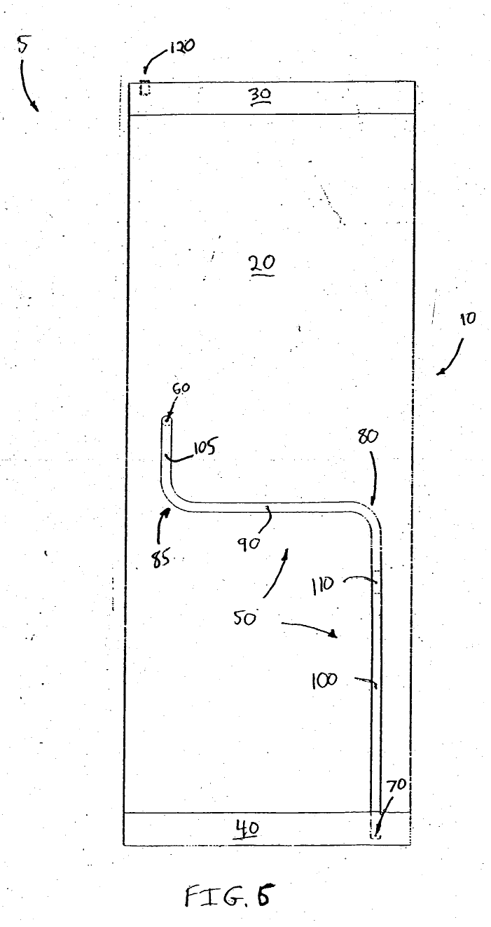

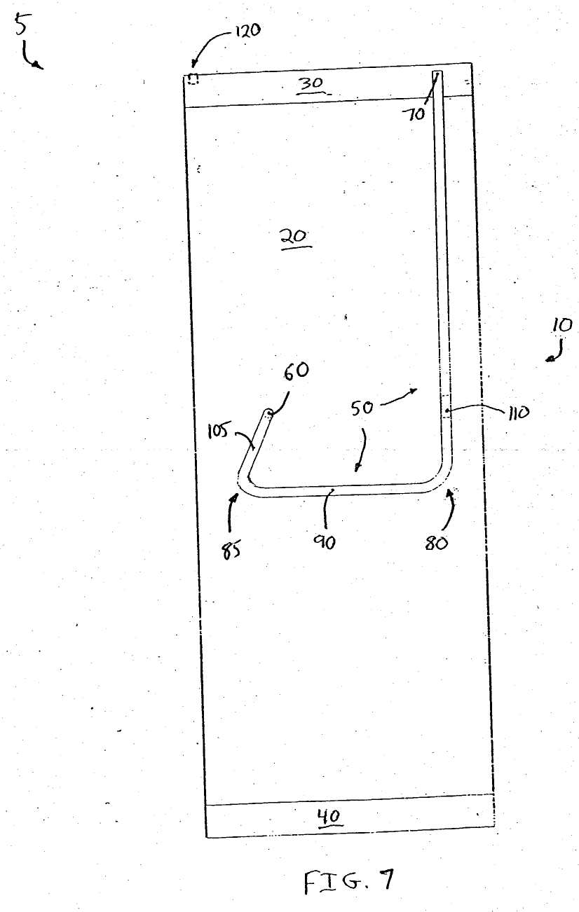

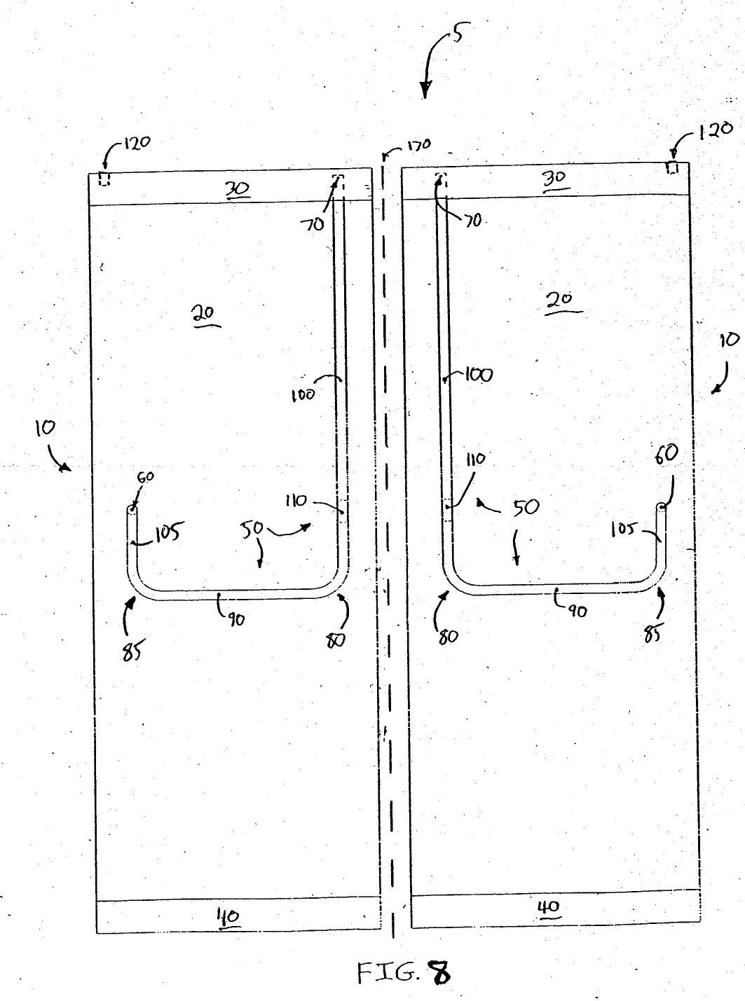

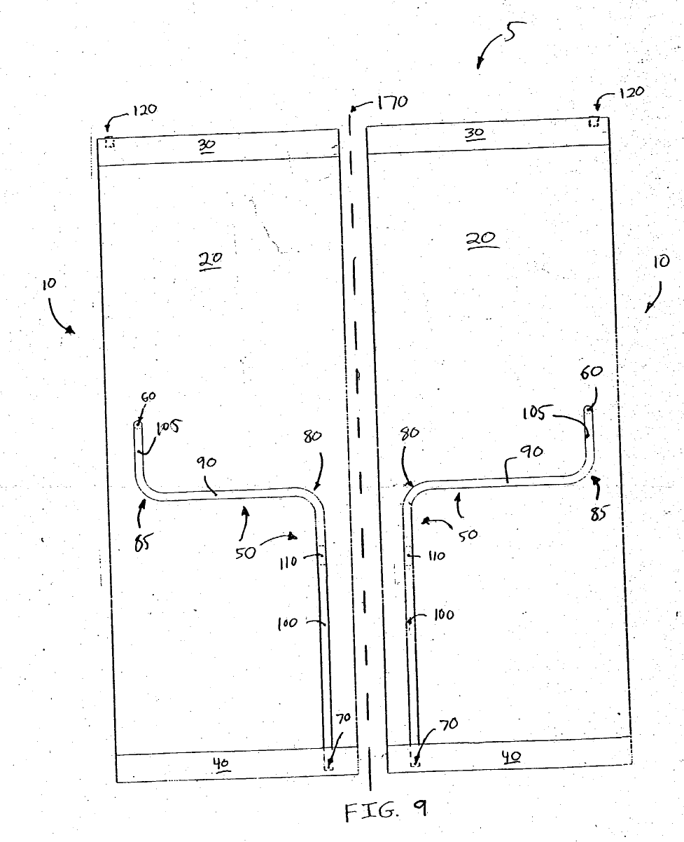

Other examples of door handles 50 used in the displaceable door handle system 5 of the present invention are illustrated in the figures. For example, in the embodiment illustrated in FIG. 4, the displaceable door handle system 5 comprises a door 10 including a panel 20 having a header 30 and footer 40. In this embodiment, the handle 50 is bent (at 80) forming a horizontal bar 90 and a vertical bar 100 that extends downward into footer 40. The handle 50 is also bent (at 85) forming a handle extension 105. An optional actuator post assembly 110 is used to actuate a latching assembly and unlock the door 10. Pivot member 120 is structured to pivotally mount door 10 to an appropriate door frame (not shown). In this embodiment, a generally 90-degree angle is provided at bend 80 such that the vertical bar 100 extends upward from the bend 80 and into header 30. Also, a generally 90-degree angle is provided at bend 85 and that handle extension 105 extends downward from actuation surface 90, but does not extend into the footer 40.

In the embodiment shown in FIG. 5, a generally 90-degree angle is provided at bend 80 such that the vertical bar 100 extends downward from the bend 80 and into bottom door rail 40. Further, a generally 90-degree angle is provided at bend 85 and that handle extension 105 extends downward from actuation surface 90, but does not extend into the bottom door rail 40. In the embodiment shown in FIG. 6, a generally 90-degree angle is provided at bend 80 such that the vertical bar 100 extends downward from the bend 80 and into bottom door rail 40. Additionally, a generally 90-degree angle is provided at bend 85 and that handle extension 105 extends upward from actuation surface 90, but does not extend into the top door rail 30.

In the embodiment shown in FIG. 7, a generally 90-degree angle is provided at bend 80 such that the vertical bar 100 extends upward from the bend 80 and into top door rail 30. In addition, a generally 60-degree angle is provided at bend 85. However, any other angles may be used.

In the embodiment shown in FIG. 8, the displaceable door handle system 5 comprises double doors 10,10. Elements analogous to those described above with respect to FIGS. 2-7 have been numbered accordingly. The doors 10,10 are mirror images of each other about centerline 170 such that one handle 50 is J-shaped and the other handle 50 has an inverted J-shape. In this embodiment, the handles 50,50 are bent (at 80,80) forming horizontal bars 90,90 and vertical bars 100,100 that extend upward into headers 30,30. In addition, a generally 90-degree angle is provided at bends 85,85 and each handle extension 105,105 extends upward from the actuation surface 90,90, but does not extend into the top door rail 30,30. Also, since the hinges 120,120 are located distally from the centerline 170, the doors 10,10 rotate outwardly and away from the centerline 170 when the handles 50,50 are pushed.

In the embodiment shown in FIG. 9, the displaceable door handle system 5 comprises double doors 10, 10. Elements analogous to those described above with respect to FIGS. 2-7 have been numbered accordingly. As before, the doors 10,10 are mirror images of each other about centerline 170. In this embodiment, the handles 50,50 are bent (at 80,80) forming horizontal bars 90,90 and vertical bars 100,100 that extend downward into bottom door rails 40,40. In addition, a generally 90-degree angle is provided at bends 85,85 and each handle extension 105,105 extends upward from the actuation surface 90,90, but does not extend into the respective top door rails 30,30.

In wired embodiments of the present invention, at least a portion of the handle 50 extends to at least one of the top door rail 30 or the bottom door rail 40. In a wireless version, the handle 50 optionally may extend to at least one of the header 30 or the footer 40, but optionally does not so extend.

In one embodiment, of mechanical switch actuation, the handle 50 is movable in reference to the actuator post 110. The actuator post 110 is used to actuate a switch assembly within the vertical bar 100 and unlock the door 10. When sufficient force is applied, the actuator post 110 enters the handle 50 and activates a switch means within the handle's interior unlocking the door.

The door 10 is adapted be attached to a door frame 240 by any mounting apparatus. As seen in FIG. 2, in one embodiment, a door pivot assembly 115 is provided. In the pivot assembly 115, the top door rail 30 includes a pivot member 120 extending therefrom and being received in a female pivot receiving plate 125. A similar or other type of pivoting assembly may also be provided at the bottom of the door 20 as well. Alternatively, the door is hinged by any hinging apparatus at one of its sides, such that it can be opened by rotating using hinge apparatus. Alternatively, the door may be a pocket door in which the door panel 20 may slide into a space (not shown) provided in the door frame.

According to some embodiments, the panel 20 is a frameless glass panel 20 formed of tempered glass (or any other type of clear material of sufficient strength and structural integrity to serve as a door). However, it should be understood to those of skill in the art that the panel 20 could be made from wood, metal, plastic or other material without departing from the scope of the present invention and that any form of mounting apparatus may be used. As discussed above, any form of assemblies can be used to mount the handle. For example, pivoting assemblies 60,70 can be mounted via holes and mechanical securing assembly (such as bolts, screws, posts or any other apparatus of sufficient strength to mount the assemblies) in the door panel 20 that entirely or partially extend through the holes. Alternatively they can be adhesively mounted. Likewise the optional actuator post 110 can be mounted via a hole in the door panel 20, or alternatively via adhesive.

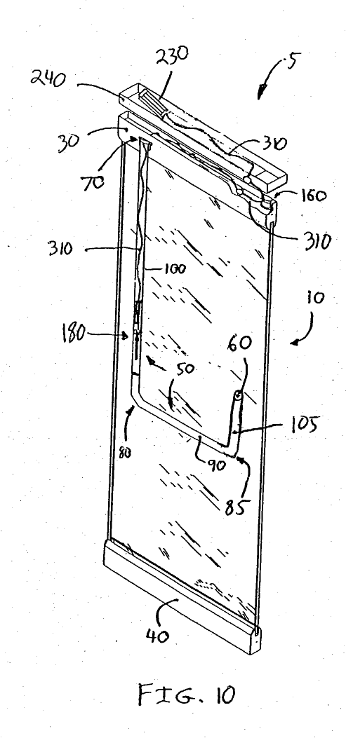

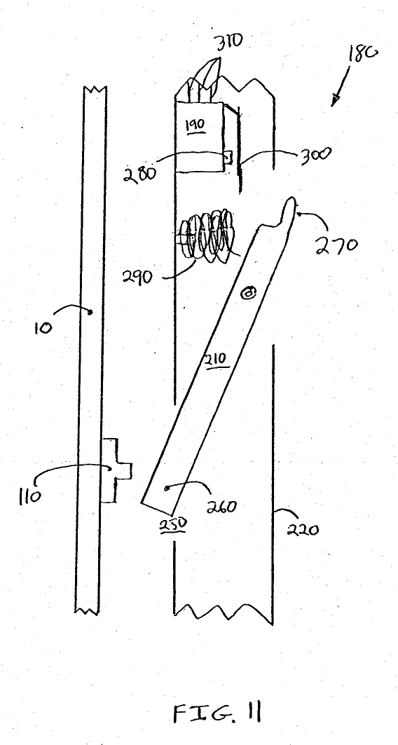

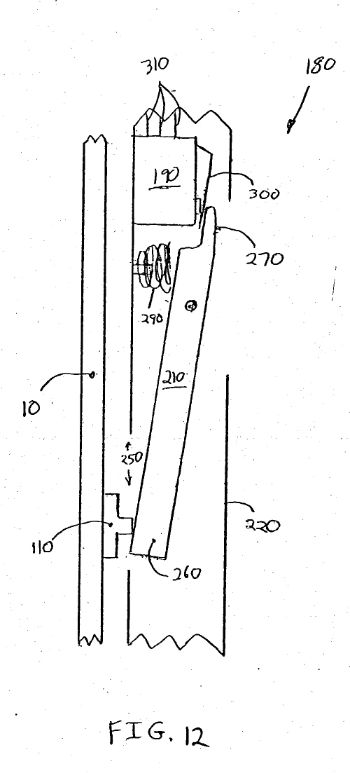

In the embodiment shown in FIGS. 10-12, the displaceable door handle system 10 includes an electronic exit control device 180 mounted inside of the vertical bar 100. As illustrated in FIGS. 11 and 12, the exit control device 180 includes a switch assembly 190 and a teeter-totter linkage 210 mounted within tubing 220. Preferably, the tubing 220 is stainless steel tubing 220 with a high quality finish. According to some embodiments, the switch assembly 190 is a single pole, double throw (“SPDT”) sealed switch 190, which has a long operational life and includes a waterproof precision body. When the handle 150 is depressed, the switch assembly 190 activates or de-activates a latch or lock assembly 230 located at least partially within door frame conduit 240.

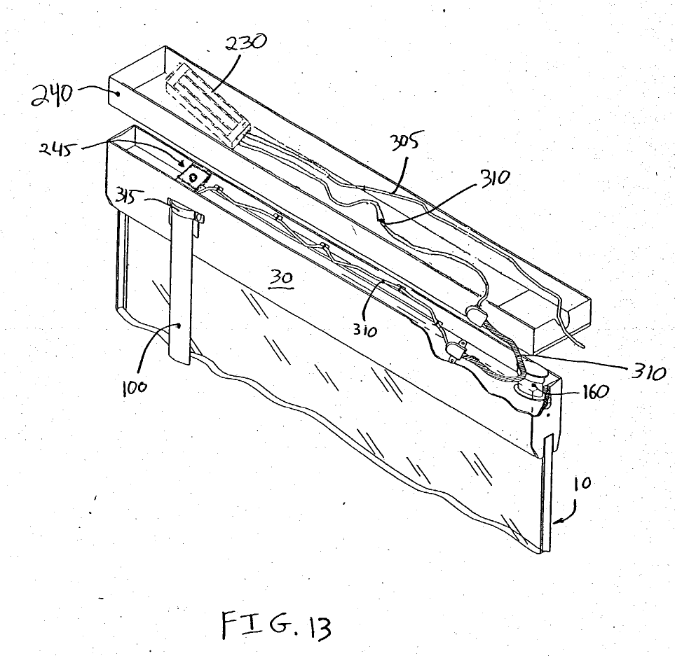

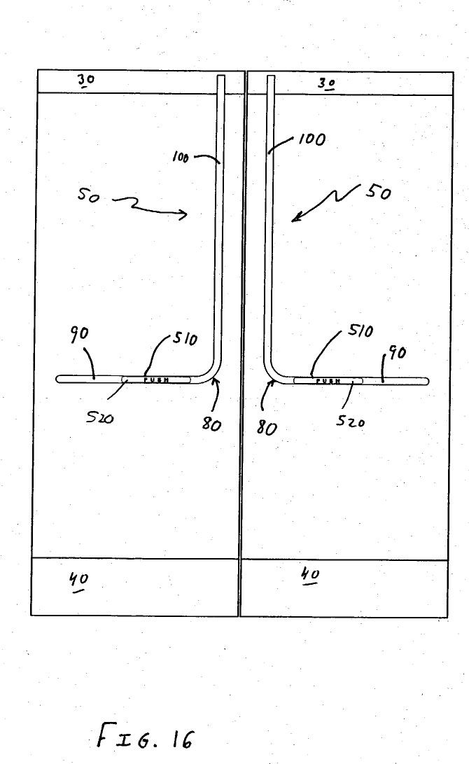

As illustrated in FIGS. 13 and 15, the latch or lock assembly 230 located within header 30 and door frame conduit 240 on top of door 10. However, as would be understood to one of ordinary skill in the art, the latch or lock 230 may also be located within the header 30 or footer 40 without departing from the scope of the present invention. In some embodiments, the latch or lock assembly 230 comprises an electromagnetic lock 230 includes an electromagnetic component 235 in the door frame conduit 240 and an armature 245 located within header 30. The armature 245 is dimensioned to fit at least partially within a similarly shaped opening 255 in the electromagnetic component 235. Activation or deactivation of the assembly 230 causes the armature 245 to disengage from the electromagnetic component 235, which unlocks the door 10. The assembly 230 is powered by a power source (not shown) through wires 305 in door frame conduit 240. According to other embodiments, the electromagnetic lock 230 is activated by a solenoid, wherein the door frame conduit 240 houses a solenoid-activated locking mechanism. In one type of locking mechanism, a latching member (not shown) is retracted by actuation of the locking mechanism. As the latching member is retracted, it is withdrawn from corresponding receiving area in the header 30 or footer 40, and thereby unlatching or unlocking the system.

Upon application of a pushing force on handle 50, the exit control device 180 moves toward the actuator post 110. When sufficient force is applied, the actuator post 110 enters an aperture 250 in tubing 220 and pushes on a first end 260 of the teeter-totter linkage 210, which causes a second end 270 of the teeter-totter linkage 210 to depress button 280 activating the switch 190. The force applied must be large enough to overcome the bias of coil spring 290 and leaf spring 300.

According to some embodiments, the switch 190 is an analog switch 190 that sends an analog electronic signal through electrical wires 310. As best seen in FIGS. 10, 13 and 15, the wires 310 are threaded through the vertical bar 100, up through flexible conduit 315, into header 30 through aperture 325 and wire fastener 335, laterally through the top door rail 30 toward the hinge 160 side of the door 10, and then up from the top door rail 30 and into the door frame conduit 240. The wires 310 then proceed laterally away from the hinge 160 side through the door frame conduit 240 and to the lock 230. The electronic signal from the switch flows through the wires 310 and activates or de-activates the lock 230, which causes the door 10 to unlock and be opened. Activating the switch 190 changes the electronic state in the wires 310, which in turn changes the electronic state in the lock 230 within door frame conduit 240. In other words, the analog signal is transmitted via the wires 310 from the switch 190 to the lock 230 instructing it to unlock.

According to other embodiments, the switch 190 acts as an analog/digital converter, whereby pushing on the door handle 50 causes the teeter-totter linkage 210 to activate the switch 190. In this embodiment, the switch 190 sends a digital signal through the wires 310 to the lock 230, which is digitally triggered to open.

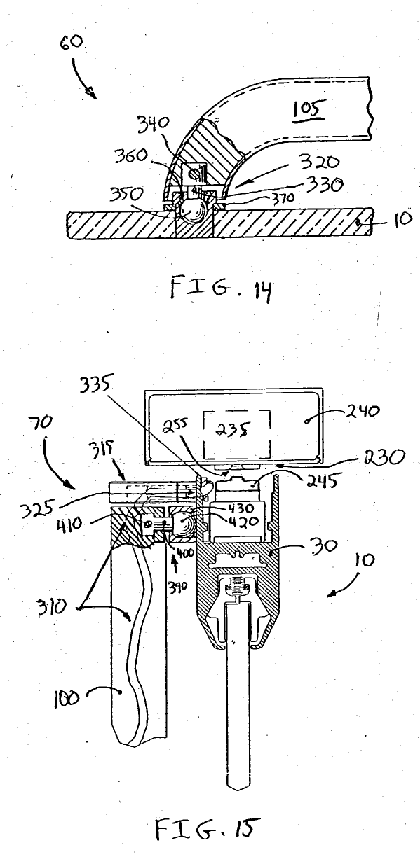

With further reference to FIG. 2, the handle 50 is mounted to the glass door panel 20 at a pair of pivot points 60,70. The pivot points 60,70 permit the movement of the handle 50 required to activate the switch 190. As seen in FIG. 14, at pivot point 60, the handle extension 105 is bent to facilitate attachment to the door 10 via pivot assembly 320. The pivot assembly 320 includes a pivot member 330 having a pivot base 340 fixedly mounted within the handle extension 105 and a pivot ball 350 pivotally mounted within a socket 360. An annular flange 370 surrounds the socket 360 preventing air and water from seeping in. The socket 360 may be inserted within a mounting hole 380 drilled into the glass door 10.

As seen in FIG. 15, at pivot point 70, the vertical bar 100 is attached to the header 30 by pivot assembly 390. Pivot assembly 390 includes a pivot member 400 having a pivot base 410 fixedly mounted within the vertical bar 100 and a pivot ball 420 pivotally mounted within socket 430. The socket 430 may be attached to the top door rail 30 by conventional means including, but not limited to screws, bolts and adhesive. The wires 310 pass through the vertical bar 100, through the flexible conduit 315 and into top door rail 30. The flexible conduit 315 is bendable to allow for movement of the vertical bar 100 when activating the switch 190.

In one embodiment an “L” shaped displaceable panic door handle 50 is provided, as illustrated in FIG. 16. In this embodiment a directional force application marker 510 is provided. Any such marker may be used that will give a directional indication. For example, in the illustrated embodiment, an optional background or set-apart highlight 520 is provided. In the illustration, this is a flat oval shaped etching, decal, indentation, outline, mark etc. Of course the background or set-apart highlight 520 is optional and none may be used as well. Within the flat oval 520, a directional force application indicator 510 is provided. Examples are the word “push” or “pull” or an arrow sign or a design of a person in action etc. In the illustrated embodiment of FIG. 16, the directional force application marker 510 is positioned on the horizontal bar portion 90, adjacent bend 80. However, the force application marker 510 can also be positioned at any location on the door handle 50 to provide force directional marking. For example it can be located on the other side of horizontal bar 90, it can be centered on horizontal bar 90, on bend 80, or it can be located at any position on vertical bar 100. In an example of this aspect of the invention, a panic handle 50 was provided as illustrated in FIG. 16, with the directional force application marker 510 positioned on the horizontal bar 90 slightly off-center and adjacent bend 80. It was determined that the marker would assist users in operating the handle 50. A directional force application marker 510 also can be positioned on other shapes of door handles at any desired location, such as on the J-shaped handle of the present invention discussed previously, or the other shaped handles of the present invention and discussed previously.

Thus, it is seen that a door handle assembly is provided. One skilled in the art will appreciate that the present invention can be practiced by other than the preferred embodiments which are presented in this description for purposes of illustration and not of limitation, and the present invention is limited only by the claims that follow. It is noted that equivalents for the particular embodiments discussed in this description may practice the invention as well.

What is claimed is:

1. A door assembly comprising:
a door panel;
at least one mounting assembly; and
a movable component mounted to the door panel via said at least one mounting assembly and displaceably movable relative to said door panel, the movable component including:
an actuation surface; and
a lever arm between said actuation surface and said mounting assembly.

2. The door assembly of claim 1 further comprising a resistance element mounted to said door panel resisting displacement of said movable component relative to said door panel.

3. The door assembly of claim 1 further comprising:
at least two of said mounting assemblies;
and wherein the movable component further includes:
a generally vertical portion including a first end mounted to the door panel using a first of said mounting assemblies;
a generally horizontal portion generally extending horizontally from a second end of the vertical portion and including said actuation surface as at least a portion of said generally horizontal portion; and wherein:
the lever arm extending at an angle from said horizontal portion wherein said lever arm is mounted to a second of said mounting assemblies.

4. The door assembly of claim 1, further including a latching assembly responsive to the movement of the handle relative to the door panel.

5. The door assembly of claim 4, wherein the latching assembly comprises an electromagnetic lock.

6. The door assembly of claim 1, wherein each mounting assembly comprises a pivot base and a pivot ball.

7. The door assembly of claim 1, wherein the movable component is substantially J-shaped.

8. The door assembly of claim 3, wherein the vertical portion extends up from the horizontal portion and into a top door rail located on top of the door panel.

9. The door assembly of claim 3, wherein the lever arm extends vertically up in relation to the horizontal portion.

10. The door assembly of claim 3, wherein the lever arm extends vertically down in relation to the horizontal portion.

11. The door assembly of claim 3, wherein the vertical portion extends down from the horizontal portion and into a bottom door rail located at the bottom of the door panel.

12. The door assembly of claim 1, wherein a distal end of the lever arm is horizontally displaced a sufficient distance form the horizontal portion such that the door can be opened using a force of less than a predetermined amount of force on the horizontal portion.

13. The door assembly of claim 12, wherein the predetermined amount of force is 15 pounds.

14. A door assembly comprising:
a door panel;
mounting means for displaceably mounting a movable component to said door panel for movement relative to said door panel, the movable component including:
an actuation surface; and
a lever arm means for providing a spatial separation between said mounting means and said actuation surface.

15. The door assembly of claim 14 further comprising a resistance means mounted to said door panel for resisting displacement of said movable component relative to said door panel.

16. The door assembly of claim 14 wherein:
the mounting means includes at least two portions; and
the movable component further includes:
a generally vertical portion including a first end mounted to the door panel via a first of said portions of the mounting means;
a generally horizontal portion generally extending horizontally from a second end of the vertical portion and including said actuation surface as at least a portion of said generally horizontal portion; and wherein:
the lever arm means extends at an angle from said horizontal portion wherein said lever arm is mounted to a second of said portions of the mounting means.

17. A displaceable door handle system comprising:
a door handle displaceably mounted on a door panel, the door handle including an actuation surface; and
a directional force application marker on the actuation surface.

18. The displaceable door handle of claim 17 wherein the door handle is substantially “L” shaped, having a generally horizontal portion including the actuation surface and a generally vertical portion.

19. The displaceable door handle of claim 17 wherein the door handle is substantially “J” shaped, having a generally horizontal portion including the actuation surface and two generally vertical portions.

20. The displaceable door handle of claim 17 wherein the directional force application marker comprises the word “push”.
